(19) United States
(12) Patent Application Publication
(10) Pub. No.: US 2024/0109091 A1
(43) Pub. Date: Apr. 4, 2024

(54) SYSTEM FOR COATING OBJECTS WITH COATING MATERIAL, AND METHOD FOR COATING OBJECTS WITH COATING MATERIAL

(71) Applicant: GEMA SWITZERLAND GMBH, St. Gallen (CH)

(72) Inventors: Axel Forster, Engelburg (CH); Roman Mlakar Trümpy, Kreuzlingen (CH); Felix Mauchle, Abtwil (CH)

(21) Appl. No.: 18/257,825

(22) PCT Filed: Dec. 15, 2021
(86) PCT No.: PCT/EP2021/085879

§ 371 Date: Jun. 15, 2023

(30) Foreign Application Priority Data
Dec. 18, 2020 (DE) 10 2020 134 087.7

(51) Int. Cl. B05B 12/12; B05D 1/12

(52) U.S. Cl. CPC B05B 12/122; B05D 1/12

(57) ABSTRACT

An installation is disclosed for coating objects, preferably automatically, with coating material, the installation having a coating station with at least one coating gun for spraying coating material, in particular as required, in the direction of a coating region, and having a conveying apparatus, by means of which objects to be coated can be transported, in particular continuously, through the coating region. Provision is made, in particular, for the installation to have a device for detecting the presence and/or absence, in a monitoring region located upstream of the coating station—as seen in the conveying direction of the conveying apparatus—of an object to be coated, wherein there is also provided a control device, which is designed to activate the at least one coating gun of the coating station in dependence on the detection result of the device for detecting the presence and/or absence of an object to be coated.

### CROSS-REFERENCE TO RELATED APPLICATION(S)

This application is the national phase of PCT Application No. PCT/EP2021/085879 filed on Dec. 15, 2021, which claims priority to German Application No. 102020134087.7 filed on Dec. 18, 2020, the contents of which are incorporated herein by reference in their entirety.

### BACKGROUND

The present disclosure relates in general to the surface treatment of workpieces and in particular to the preferably automatic coating of workpieces with coating material, in particular coating powder.

According to one aspect of the present disclosure, same relates to a system for the preferably automatic coating of objects with coating material, particularly coating powder, wherein the system comprises a coating station having at least one coating gun for the spraying of coating material, in particular when required, in the direction of a coating area. The coating station can be provided at least partially inside a coating booth or coating cell, for example.

Coating booths or coating cells for coating workpieces, in particular with coating powder, are generally known from the prior art. Such coating booths or coating cells usually comprise a coating chamber with two oppositely disposed workpiece passageways. Normally, the coating booth or coating cell is allocated a conveyor mechanism for the, in particular continuous, transport of objects to be coated through the coating area of the coating station.

For example, printed publication EP 0 071 756 A2 relates to a coating booth having a conveyor mechanism which transports the objects to be coated through the interior of the booth via an entrance and an exit. Using a spraying device, for example in the form of a manual spray gun, coating material can be sprayed as required toward the coating area inside the coating booth through a wall panel by way of at least one openable door. However, automatically controlled spray guns can also be provided. The at least one door also allows access to the booth interior. The spray guns can all be located on the same side of the booth. Applicable wall panels with slits for spray guns to pass through can also be provided on the opposite side.

Instead of a conveyor mechanism for automatically transporting the objects to be coated through the interior of the booth, the objects to be coated can also be brought into the booth interior manually and—following a coating procedure—taken back out again. Accordingly, the term “conveyor mechanism” as used herein is intended to include devices with which an object to be coated is manually transported/conveyed through the coating area, which is preferably at least partially inside a coating booth or coating cell.

A conveyor mechanism for automatically transporting the objects to be coated through the booth interior can in particular be arranged beneath the floor of the coating booth and can comprise a workpiece carrier which extends into the coating chamber of the coating booth through a conveyor slot in the booth floor.

Coating booths having such “floor conveyors” are used particularly in the coating of higher value workpieces since a high coating quality can be achieved by arranging the conveyor beneath the booth floor. This is particularly due to the fact that “conventional” conveyors for the suspended transport of workpieces through the coating chamber can facilitate the falling of dirt particles or powder residues from the conveyor mechanism, which can lead to irregularities in the coating.

When coating workpieces with coating material, in particular coating powder, there is a need to prevent any coating irregularities or coating defects, particularly from the very outset; i.e. during the very coating procedure itself.

Various approaches are known for preventing or at least minimizing coating irregularities or coating defects, particularly for liquid coating applications. As a rule, the coating is usually only corrected in these conventional approaches after the coating has cured or hardened. Undertaking such subsequent defect correction; i.e. after the actual coating process, generally necessitates applicable tools or tooling.

However, in view of the tools or tooling used for correcting defects, such as those proposed in printed publication DE 19 539 065 A1, for example, only simple surfaces without complex geometric shapings can be corrected.

Specifically, the tool proposed in printed publication DE 19 539 065 A1, for example, has to be placed on the surface of the already coated object such that given a coating defect in a forming surface, for example, the tool would need to be adapted to the respective surface, which is expensive and time-consuming.

Furthermore, the approaches known from this prior art only enable correcting defects on a cured coating since positioning the tooling on the surface of the already coated object introduces additional coating defects into the still uncrosslinked or respectively uncured coating.

In particular, the approaches known from the prior art are therefore generally not suitable for actually repairing coating defects. In fact, coating defects are merely concealed in the known approaches, in that only parts of the coating defect are removed or entire areas of the coating are removed and reapplied.

### SUMMARY

On the basis of this problem as set forth, the present disclsoure is based on the task of specifying a method as well as a system for the preferably automatic coating of objects with coating material, in particular coating powder, wherein an optimal coating result is already achievable during the coating process itself, and that in fact not needing to hinge on the experience and skill of the operator of the system or the user of the coating gun. Particularly to be achieved is a consistent coating quality with a simultaneous reduction in manual coating work.

A further task of the present disclosure is that of specifying a system for the preferably automatic coating of objects with coating material, in particular coating powder, which is not only able to achieve optimal coating results even with objects of complex geometrical shapings or with recesses but which can concurrently save resources (coating material and energy). The efficiency of the first application is furthermore to be increased, in particular without any manually assisted coating.

This task is in particular solved by a system for the preferably automatic coating of objects with coating material, particularly coating powder, wherein the system comprises a coating station having at least one coating gun for the spraying of coating material, in particular as required, in the direction of a coating area as well as a conveyor mechanism for the, in particular continuous, transport of objects to be coated through the coating area.

According to the present disclosure, the system in particular comprises a device for detecting the presence and/or absence of an object to be coated in a monitored area located upstream—seen in the conveying direction of the conveyor mechanism—of the coating station. A control device is furthermore provided which is designed to control the at least one coating gun of the coating station as a function of the detected result and in particular after a delay.

The provision of a corresponding device for detecting the presence and/or absence of an object to be coated enables dynamically controlling the at least one coating gun of the coating station, and that particularly only when the object to be coated is actually situated in the coating area of the coating station.

Doing so enables simply yet effectively achieving significant savings in coating material and reduced overspray, which ultimately can also be coupled with improved coating quality.

The device for detecting the presence and/or absence of an object to be coated preferably comprises a sensing device and/or a non-contact sensor system, particularly in the form of a light barrier and/or the form of a light curtain, arranged in the monitored area, although other implementations are of course also possible.

A light barrier within the meaning of the present disclosure is a system which detects the interruption of a beam of light and displays it as an electrical signal. This enables the presence and/or absence detection device to contactlessly detect the objects which are to be coated and moving through the monitored area.

The control device is preferably designed to applicably control the at least one coating gun of the coating station as a function of the detected result and as a function of a conveyance speed and/or a distance between the monitored area and the coating area.

According to further developments, the device for detecting the presence and/or absence of an object to be coated is designed to also detect the conveyance speed at which the object to be coated is conveyed through the monitored area.

The disclosed system in particular enables objects to be coated automatically. In the preferably automatic coating method, a conveyor mechanism is used to convey at least one object to be coated along a transport path through a coating area of a coating station, and that preferably at a constant conveyance speed. The presence or absence of an object to be coated is further detected in the disclosed coating method in a monitored area situated in the transport path of the at least one object to be coated and upstream—seen in the conveying direction of the conveyor mechanism—of the coating area.

The coating method according to the present disclosure in particular provides for at least one coating gun to spray coating material towards the coating area in the coating station, in particular after a delay, upon an object to be coated being detected as present in the monitored area. The coating material is thereby preferably sprayed in the direction of the coating area after a delay contingent on the conveyance speed and a distance between the monitored area and the coating area.

The disclosed coating method furthermore particularly provides for the at least one coating gun to not spray any coating material towards the coating area in the coating station, particularly after a delay, when no object to be coated is detected as being present in the monitored area. Also preferential here is for the at least one coating gun to be deactivated after a delay contingent on the conveyance speed and a distance between the monitored area and the coating area.

According to a further aspect, the task on which the present disclosure is based is also and in particular solved by a system for the preferably automatic coating of objects with coating material, particularly coating powder, wherein the system comprises a coating station having at least one coating gun for the spraying of coating material, in particular as required, in the direction of a coating area as well as a conveyor mechanism for the, in particular continuous, transport of objects to be coated through the coating area, wherein according to the present disclosure, the system in particular comprises a device for detecting a size, geometry and/or contour of at least one area of an object to be coated in a monitored area situated upstream—seen in the conveying direction of the conveyor mechanism—of the coating station.

A positioning device is thereby preferably allocated to the coating station in order to position the at least one coating gun relative to the coating area, in particular selectively and/or as required. A control device designed to applicably control the positioning device of the coating station as a function of the detected size, geometry and/or contour of the object to be coated, and in particular after a delay, can furthermore be provided.

According to this further aspect of the present disclosure, the coating system can of course also comprise a device for detecting the presence and/or absence of an object to be coated in a monitored area situated upstream—seen in the conveying direction of the conveyor mechanism—of the coating station.

In this context, further providing a control device designed to applicably control the at least one coating gun of the coating station as a function of the detected result and in particular after a delay would make sense.

In other words, a preferably automatic coating system is in particular specified by means of which the presence and/or absence of an object to be coated is detected on the one hand, and the size, geometry and/or contour of at least one area of the object to be coated is detected on the other, this ensuing at a location upstream of the coating station—as seen in the conveying direction of the conveyor mechanism. With this information, the at least one coating gun of the coating station and in particular the positioning device of the coating station are adjusted via the control device such that
(i) the at least one coating gun preferably only sprays coating material towards the coating area when the object to be coated is actually within the coating area; and/or
(ii) the at least one coating gun is preferably dynamically positioned in the coating area of the coating station by means of the positioning device such that a predefined or definable (and in particular optimal with regard to coating material application) distance and/or a predefined or definable (and in particular optimal with regard to coating material application) alignment/orientation to the surface of the object to be coated is/are set and/or maintained between the coating gun and the surface of the object to be coated.

Thus, the device for detecting a size, geometry and/or contour of at least one area of an object to be coated provides dynamic contour detection which, particularly in the case of an automated coating system, affords optimum coating results even when the object to be coated is of complex geometry. It is consequently possible to detect complex object geometries and to bring the at least one coating gun of the coating station into the optimum position for coating the object in the coating area of the coating station.

Accordingly, a method for the in particular automatic coating of objects can be implemented according to the present disclosure, wherein at least one object to be coated is conveyed along a transport path through a coating area of a coating station with the aid of a conveyor mechanism, and that preferably at a constant conveyance speed, and wherein a size, geometry and/or contour of at least one area of an object to be coated is/are detected in a monitored area situated in the transport path of the at least one object to be coated and upstream—seen in the conveying direction of the conveyor mechanism—of the coating area.

In the case of the in particular automatic coating method, a positioning device is used to position and/or align at least one coating gun in the coating station in the horizontal and/or vertical direction and/or in the conveying direction in relation to the coating area, particularly after a delay, such that when the object to be coated is conveyed through the coating area, the at least one coating gun then always has a predefined or definable distance from and/or a predefined or definable orientation to the surface of the object to be coated.

The at least one coating gun is preferably dynamically positioned and/or aligned accordingly and in particular after a delay contingent on the conveyance speed and a distance between the monitored area and the coating area.

Implementations of the present disclosure provide for the device for detecting a size, geometry and/or contour of at least one area of an object to be coated to comprise a first optical detection system, particularly in the form of at least one first laser scanning system designed to scan and/or sweep the at least one area of the object to be coated in the monitored area via at least one laser beam, particularly in a line or grid pattern, in order to measure it.

The term “laser scanning system” as used herein is generally to be understood as a system in which a laser beam can sweep over surfaces or bodies in a line or grid pattern in order to measure or process them or to generate an image.

A laser scanning system according to the present disclosure in particular comprises a laser scanner, thus sensors which deflect the laser beam accordingly. Laser scanners can also be used which also detect, in addition to the object's geometry, the intensity of the reflected signal.

A laser scanner used in the laser scanner system preferably consists of a scanhead and driver and control electronics. The electronics consists of an electronic power component which supplies the electrical power for the drives and scanner software running on e.g. a PC or embedded system for activating the driver electronics. The laser beam is deflected in the scanhead, its deflection angle being measured and preferably electronically controlled.

In the first optical detection system, or in the at least one first laser scanning system of the first optical detection system respectively, it is not absolutely necessary for the at least one laser beam to be deflected relative to the object to be measured and horizontally relative to the conveying direction of the object to be measured in order to achieve a laser beam sweep since the object to be coated and measured is preferably transported, in particular continuously, through the monitored area by means of the conveyor mechanism; i.e. at a preferably constant conveyance speed.

In particular, the at least one laser beam of the first laser scanning system runs in a first direction relative to the conveying direction of the conveyor mechanism and in particular perpendicular or at least substantially perpendicular to the conveying direction.

In other words, the first laser scanning system in this embodiment is preferably orthogonally aligned with respect to the conveying direction of the conveyor mechanism.

The first laser scanning system is preferably realized as a polar measuring laser scanning system and designed to vertically sweep and/or scan the at least one area of the object to be coated in the monitored area by means of the at least one laser beam.

The thusly achieved object/contour detection enables increasing process reliability and achieving optimal coating results. The objects to be coated are thereby detected with the (first) laser scanning system and the at least one coating gun is—based on the geometric structure of the object to be coated in the coating area—optimally positioned and/or aligned dynamically in the coating station.

The coating station preferably comprises a plurality of coating guns which are preferably individually positionable in the coating station according to the object's geometric structure using the dynamic contour detection.

A further development of the aforementioned embodiments of the automatic coating system provides for the device for detecting a size, geometry and/or contour of at least one area of an object to be coated to further comprise at least one second laser scanning system designed to scan and/or sweep the at least one area of the object to be coated in the monitored area of the device for detecting a size, geometry and/or contour, particularly in a line or grid pattern, via at least one laser beam in order to measure it, wherein the at least one laser beam of the at least one second laser scanning system runs obliquely to the conveying direction of the conveyor mechanism.

This further development thus also enables the detecting of the thin geometries of the object to be coated such as, for example, struts or side walls of boxes. Such thinner geometries are only partially detectable with the first laser scanning system aligned orthogonal to the conveying direction of the conveyor mechanism depending on the conveyance speed.

Providing a further second laser scanning system, its at least one laser beam aligned obliquely to the conveying direction of the conveyor mechanism, enables detecting the geometries of the object to be coated/measured from another perspective. Doing so significantly increases the resolution able to be achieved with the device for detecting a size, geometry and/or contour, and particularly do so independent of the conveyance speed of the conveyor mechanism.

The at least one laser beam of the at least one second laser scanning system particularly runs at an obtuse angle relative to the conveying direction of the conveyor mechanism.

Alternatively or additionally thereto, the at least one laser beam of the at least one second laser scanning system runs at an acute angle relative to the conveying direction of the conveyor mechanism.

The at least one second laser scanning system is preferably realized as a 2D laser scanning system and designed to vertically sweep and/or scan the at least one area of the object to be coated in the monitored area via the at least one laser beam in order to measure the size, contour or geometry of the object.

It is in particular entirely conceivable for the at least one second laser scanning system to be designed as a separate system from the first laser scanning system.

However, a (single) compact system in which the first and the at least one second laser scanning system are jointly integrated is preferential in order to minimize the overall size. A compact system as such, which realizes the function of the first and the at least one second laser scanning system, is in particular designed to at least partially scan a 3D surface of the object to be coated in the monitored area of the device for detecting a size, geometry and/or contour.

Scanning a 3D surface with a laser beam requires different scanning mechanisms to move the laser across the surface. The scanning process can thereby be realized by means of, for example, two orthogonally mounted mirrors. Alterna-tively thereto, the laser beam can scan unidirectionally with a scanning mirror, which rotates via a mechanical device.

According to implementations of the first and/or the at least one second laser scanner system, at least one triangulation scanner is used, with which a line instead of a single dot is projected. The scan is thereby limited to one direction. Projections of multiple lines or stripe patterns allow the recording of entire fields.

The simplest way to induce a scanning movement is to change the orientation of a mirror reflecting the laser beam. In a spatial dimension, this can be done by a galvanometer drive, by a continuously rotating mirror or by a continuously rotating reflecting prism (polygon mirror), depending on whether a freely programmable movement (vector control) or a periodic movement (line, image) is desired. A distinction is thus usually made between vector scanners and raster scanners.

For two-dimensional deflection, either a mirror needs to be deflected in two directions—as is the case particularly with slow systems—or two orthogonally rotatable stationary mirrors are placed close together via which the laser beam is reflected. The two plane/polygon mirrors are then driven by a respective galvanometer drive or electric motor.

The positioning device of the coating station is in particular designed to horizontally move the at least one coating gun relative to the coating area perpendicular to the conveying direction of the conveyor mechanism. The coating station thereby preferably comprises a plurality of coating guns preferably arranged at least to some extent vertically one above the other, wherein the coating guns are each oriented toward the coating area and can be horizontally moved individually relative to each other and relative to the coating area by means of the positioning device.

Alternatively or additionally thereto, the positioning device is designed to vertically move the at least one coating gun, or the individual coating guns independent of one another respectively, relative to the coating area perpendicular to the conveying direction of the conveyor mechanism.

The present disclosure further relates to a method for the automatic coating of objects with coating material, in particular coating powder.

According to embodiments of the disclosed coating method, at least one object to be coated is conveyed along a transport path through a coating area of a coating station with the aid of a conveyor mechanism, and done so preferably at a constant conveyance speed. It is in particular further provided in the disclosed coating method for a size, geometry and/or contour of at least one area of an object to be coated to be detected in a monitored area situated in the transport path of the at least one object to be coated and upstream—seen in the conveying direction of the conveyor mechanism—of the coating area.

In this context, it is in particular provided for at least one coating gun to be positioned and/or aligned in the horizontal and/or vertical direction and/or in the conveying direction relative to the coating area, particularly after a delay and preferably after a delay contingent on the conveyance speed and a distance between the monitored area and the coating area, by means of a positioning device in the coating station such that when the object to be coated is conveyed through the coating area, the at least one coating gun then always has a predefined or definable distance from and/or a predefined or definable orientation to the surface of the object to be coated.

The size, geometry and/or contour of at least one area of the object to be coated is/are preferably detected in the disclosed coating method by way of at least one first laser beam, running perpendicular to the conveying direction of the conveyor mechanism, and at least one second laser beam, running obliquely to the conveying direction of the conveyor mechanism, at least partially scanning the object.

### BRIEF DESCRIPTION OF THE DRAWINGS

The following will reference the accompanying drawings in describing an exemplary embodiment of the disclosed coating system in greater detail.

Shown are:

FIG. 1 a schematic top view of an exemplary embodiment of the coating system according to the present disclosure; and

FIG. 2 a schematic side view of the coating area of the exemplary embodiment of the coating system according to FIG. 1.

### DETAILED DESCRIPTION

The present disclosure is in particular based on the problem of automatic coating generally not being efficiently possible in the case of a wide variety of parts, complex geometries and small production lots. Covering this diversity requires either extensive manual coating or the use of a robot which needs to be separately programmed per each variation. In any case, there is an accompanying technical effort requiring well-trained personnel as well as space on and in the coating booth 2.

In conventional coating methods, all coating guns 3 are positioned together in depth (i.e. in the Y-direction) via width detection. This usually requires a clearance distance from the object 11 to be coated in the coating area 4 in order to prevent the coating guns 3 from colliding with parts of the object 11 to be coated. In contrast, a robot can follow each contour individually and precisely. This in turn requires a high degree of programming input, the storing of all part variations in the production process and a coating booth 2 having the space and corresponding exhaust air volume.

The dynamic contour detection proposed by the present disclosure offers an economical alternative to the relatively technically complex robot system.

As is described in greater detail below with reference to the accompanying drawings, laser scanner systems continuously record the external contour of the objects 11 to be coated at the entrance or in the entrance area of a coating booth 2 (coating station).

A control device 13 relays the data from the laser scanner system to a positioning device 10 which is preferably designed to position the coating guns 3, which are held by a positioning device 10 or can be positioned in some other way, at least in the vertical (Z-direction) and/or in the Y-direction perpendicular to the Z-direction and perpendicular to a transport direction (=X-direction) of the objects 11 to be coated. In particular, the positioning device 10 is designed to precisely position the coating guns 3 in the coating station in front of the object 11 to be coated in the coating station 2 individually and in continuously corrective manner. The result is maximum efficiency and optimal coating results.

The continuous contour detection integrated into the coating process by the at least one laser scanner system enables a high degree of automation even for standard systems, thereby dispensing with the time-consuming positioning of axes or the manual programming of part shapes.

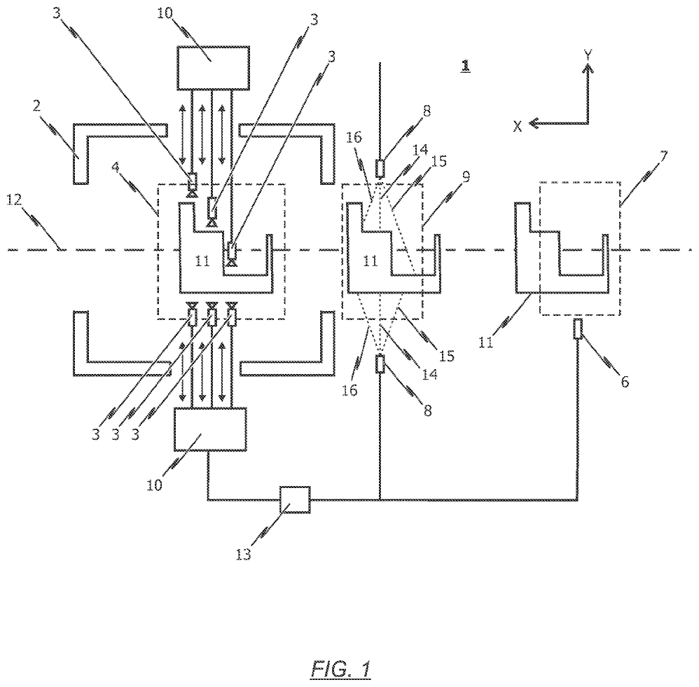

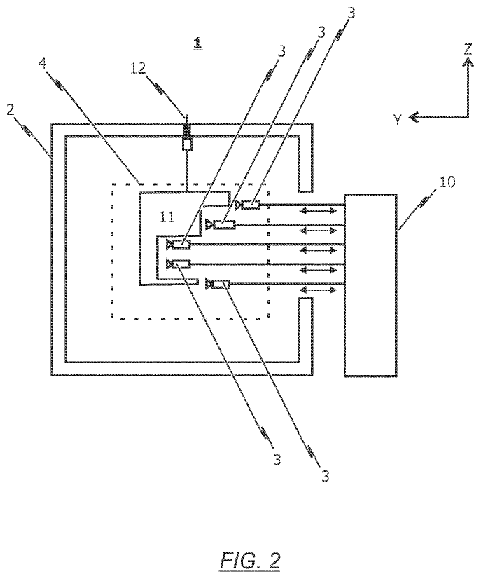

Specifically, and as can be seen from the schematic representation in FIG. 1 and FIG. 2, the exemplary embodiment of the preferably automatic coating system 1 comprises a coating station 2 designed particularly in the form of a coating booth 2.

Coating guns 3 can be moved (in the Y-direction) into the interior of the coating station 2 with the aid of a positioning device 10, particularly in order to spray coating material toward a coating area 4 as needed.

The coating system 1 is also allocated a conveyor mechanism 12 in order to transport, particularly continuously, the objects 11 to be coated through the coating area 4 in the coating station/coating booth 2. The objects 11 are preferably transported, particularly in the X-direction, at a constant and predefined or definable transport or conveyance speed.

The conveyor mechanism 12 is, for example, a so-called “floor conveyor,” in which the conveyor mechanism 12 is arranged beneath the compartment floor of the coating booth 2.

Alternatively thereto, however, it is also conceivable for the objects 11 to be coated to be transported through the coating area 4 of the coating station 2 as suspended objects.

As FIG. 1 indicates, the coating booth 2 forming the coating station has—seen in the transport direction of the conveyor mechanism 12—an upstream entrance and a downstream exit. The coating area 4 is provided inside the coating booth 2 between the entrance and the exit.

By means of the aforementioned positioning device 10, the individual coating guns 3 are positioned and/or aligned relative to the object 11 to be coated through openings in the side walls.

The coating system 1 is characterized in that it comprises a device 6 for detecting the presence and/or absence of an object 11 to be coated in a monitored area 7 located upstream—seen in the conveying direction of conveyor mechanism 12—of the coating station 2. This device 6 for detecting the presence and/or absence of an object 11 to be coated is in particular a light barrier or a light curtain.

The device 6 for detecting the presence and/or absence of an object 11 to be coated in the monitored area 7 situated upstream—seen in the conveying direction of the conveyor mechanism 12—of the coating station 2 enables objects 11 to be coated automatically, wherein resources (in particular coating material) can be saved since excessive overspray is effectively prevented.

In the preferably automatic coating process, the objects 11 to be coated are conveyed along a transport path through the coating area 4 of a coating station 2 via the conveyor mechanism 12, and preferably done so at a constant conveyance speed. The device 6 for detecting the presence and/or absence of an object 11 to be coated on the transport path of the objects 11 to be coated and situated upstream—seen in the conveying direction of the conveyor mechanism 12—of the coating area 4 detects the presence or absence of an object 11 to be coated in monitored area 7.

The disclosed coating method particularly provides for at least one coating gun 3 to spray coating material in the coating station 2 in the direction of the coating area 4, in particular after a delay, upon the presence of an object 11 to be coated being detected in the monitored area 7. The coating material is thereby preferably sprayed toward the coating area 4 after a delay contingent on the conveyance speed and a distance between the monitored area 7 and the coating area 4.

The disclosed coating method furthermore in particular provides for no coating material to be sprayed by the at least one coating gun 3 in the direction of the coating area 4 in the coating station 2, particularly after a delay, upon the absence of any object 11 to be coated being detected in the monitored area 7.

It is preferential here as well for the at least one coating gun 3 to be deactivated after a delay contingent on the conveyance speed and a distance between the monitored area 7 and the coating area 4.

In particular, the signals from the device 6 for detecting the presence and/or absence of an object 11 to be coated are thus fed to a control device 13 designed to control the coating guns 3 of the coating station 2 as a function of the detected result and in particular after a delay.

An encoder which interacts with the conveyor mechanism 12 is preferably provided which is designed to detect the conveyance speed at which the object 11 to be coated is conveyed through the monitored area 7.

With this information, the control device 13 can selectively activate or deactivate the individual coating guns 3 of the coating station 2, and namely do so as soon as the object 11 to be coated is present within the coating area 4 of the coating station 2 or, respectively, as soon as the object 11 has been transported out of the coating area 4.

A device 8 for detecting a size, geometry and/or contour of at least one area of an object 11 to be coated is additionally provided in the system 1. This device 8 measures the object 11 to be coated in a monitored area 9 situated upstream—seen in the conveying direction of the conveyor mechanism 12—with respect to the coating station 2.

The data determined with respect to the size, geometry and/or contour of the object 11 to be coated is fed to the control device 13, which in turn appropriately controls the positioning devices 10 of the respective coating guns 3, and namely such that the coating guns 3 precisely follow the contours of the object 11 to be coated in the coating area 4 of the coating station 2 or are respectively always positioned and/or aligned such that there is a predefined or definable distance between the coating guns 3 and the surface of the object to be coated 11.

According to the embodiment shown in the drawings, a first laser scanning system is used to measure the size, geometry and/or contour of the object 11 to be coated, said system being designed to sweep and/or scan at least one area of the object 11 to be coated in the monitored area 9 via at least one first laser beam 14, particularly in a line or grid pattern, in order to measure it.

The at least one first laser beam 14 of the first laser scanning system thereby runs perpendicular or at least substantially perpendicular to the conveying direction of the conveyor mechanism 12.

The first laser scanning system is in particular a polar laser scanning system or a 2D laser scanning system which is designed to vertically sweep and/or scan the at least one area of the object to be coated in the monitored area 9 via the at least one laser beam 14.

With this orthogonal alignment of the first laser scanning system, relatively thin geometries of the object 11 to be coated, such as struts or side walls, can also be detected—as long as the conveyance speed of the conveyor mechanism 12 is sufficiently low enough.

However, the resolution of the orthogonally aligned first laser scanning system is dependent upon the conveyance speed. The detection of the geometry correlates more or less linearly to the conveyance speed. In other words, a doubled conveyance speed means a doubling of the smallest geometry only just able to be detected.

In order to fine-tune the component geometry detection, the disclosed solution makes use of at least one further (second) laser scanner system which not only detects the geometries “orthogonally” but also detects geometries from at least one additional perspective. The laser is thereby provided multiple scanning planes and scans multiple planes.

To that end, an encoder attached to the conveyor mechanism 12 supplies the information as to the speed at which the object 11 to be coated is moving or the position of the object 11 respectively. The information from at least two planes and the information on the speed enable the smallest/thinnest geometries to be detected solely through coordinate transformation. The laser scanner systems measure the distance between the laser scanner and the object 11 and relay this information together with the position of the object 11 (conveyor position) to an evaluation unit. This information is essentially clocked downstream in a shift register with the conveyance speed in order to control the positioning device 10 and the guns 3. The angularly offset distance measurement with the second laser scanner system thereby increases the accuracy of the orthogonal distance measurement with the first laser scanner system.

The individual measured values and the speed are evaluated in a further step in order to individually control the individual coating guns 3 in the coating station 2.

The laser scanners of the first and the at least one second laser scanner system, which are part of the device 8 for contour detection, preferably operate two-dimensionally. They measure the distance to the object 11 in front of them so that together with the further information as to conveyance position, the individual coating guns 3 in the coating station 2 can be controlled individually and dynamically.

The scanned object contour is preferably divided into zones in order to position and activate each individual coating gun 3 of the coating station 2 accordingly. Depending on the object's geometry, the coating guns 3 oscillate in the coating station 2 or remain in a fixed position. Each individual axis of the positioning device 10 is advanced pursuant to the detected part geometry. An encoder ensures synchronization of the components with the coating gun position.

In order to minimize the overall size, a (single) compact system 8 which jointly integrates the first and the at least one second laser scanning system is preferential in the coating system 1 depicted schematically in the drawings. This system realizes the function of the first and the at least one second laser scanning system and is in particular designed to at least partially scan a 3D surface of the object 11 to be coated in the monitored area 9 of the device 8 for detecting size, geometry and/or contour.

In this context, for the purpose of detecting a size, geometry and/or contour of at least one area of an object 11 to be coated in the monitored area 9, it is particularly provided for at least one first laser beam 14 to scan and/or sweep the at least one area of the object 11 to be coated, particularly in a line or grid pattern, in order to measure it, wherein the at least one first laser beam 14 runs in a first direction relative to the conveying direction of the conveyor mechanism 12 and in particular perpendicular or at least substantially perpendicular to the conveying direction.

Furthermore provided in the coating system 1 depicted schematically in the drawings is for at least one second laser beam 15 to scan and/or sweep the at least one area of the object 11 to be coated in the monitored area 9 of the device 8 for detecting size, geometry and/or contour, particularly in a line or grid pattern, wherein the at least one second laser beam 15 runs at an acute angle relative to the conveying direction of the conveyor mechanism 12.

Moreover provided is for least one third laser beam 16 to scan and/or sweep the at least one area of the object 11 to be coated in the monitored area 9 of the device 8 for detecting size, geometry and/or contour, particularly in a line or grid pattern, wherein the at least one third laser beam 16 runs at an obtuse angle relative to the conveying direction of the conveyor mechanism 12.

In so doing, the laser scanner systems continuously record the external contour of the objects 11 to be coated at the entrance or in the entrance area of the coating booth 2 (coating station).

The data of the laser scanner systems is transmitted by a control device 13 to the positioning device 10 which in the coating system 1 shown schematically in the drawings, is designed to position the coating guns 3 held by a positioning device 10 or able to be positioned in some other way in at least the vertical (Z-direction) and/or the Y-direction and/or deflect if need be in the conveying direction.

The positioning device 10 is in particular designed to precisely position the coating guns 3 in the coating station 2 in front of the object 11 to be coated in the coating station 2 individually and in continuously corrective manner. The result is maximum efficiency and optimal coating results.

### LIST OF REFERENCE NUMERALS

1 coating system
2 coating station
3 coating gun
4 coating area
6 device for detecting the presence and/or absence of an object to be coated
7 monitored area of the device for detecting the presence and/or absence
8 device for detecting a size, geometry and/or contour
9 monitored area of the device for detecting size, geometry and/or contour
10 positioning device
11 object
12 conveyor mechanism
13 control device
14 laser beam of the first laser scanning system/first laser beam
15 laser beam of the at least one second laser scanning system/second laser beam
16 laser beam of the at least one third laser scanning system/third laser beam

1. A system for the preferably automatic coating of objects with coating material, particularly coating powder, wherein the system comprises the following:
a coating station having at least one coating gun for the spraying of coating material in the direction of a coating area;
a conveyor mechanism for transport of objects to be coated through the coating area; and
a device for detecting a size, geometry and/or contour of at least one area of an object to be coated in a monitored area situated upstream—seen in the conveying direction of the conveyor mechanism—of the coating station,
wherein the coating station is allocated a positioning device for positioning of the at least one coating gun relative to the coating area, selectively and/or as required, and wherein a control device is further provided which is designed to control the positioning device of the coating station as a function of the detected size, geometry and/or contour of the object to be coated after a delay,
wherein:
the device for detecting a size, geometry and/or contour of at least one area of an object to be coated comprises a first optical detection system in the form of at least one first laser scanning system designed to scan and/or sweep the at least one area of the object to be coated in the monitored area via at least one first laser beam in order to measure it, wherein the at least one first laser beam of the first laser scanning system runs in a first direction relative to the conveying direction of the conveyor mechanism which runs perpendicular to the conveying direction, and
the device for detecting a size, geometry and/or contour of at least one area of an object to be coated comprises at least one second optical detection system in the form of at least one second laser scanning system designed to scan and/or sweep the at least one area of the object to be coated in the monitored area of the device for detecting a size, geometry and/or contour, in a line or grid pattern, by means of at least one second laser beam, in order to measure it, wherein the at least one second laser beam of the at least one second optical detection system runs in a different second direction relative to the conveying direction of the conveyor mechanism from the first direction which runs obliquely to the conveying direction of the conveyor mechanism.

2. The system according to claim 1,
wherein the at least one first laser scanning system is designed as a polar measuring laser scanning system to vertically sweep and/or scan the at least one area of the object to be coated in the monitored area in a line or grid pattern by means of the at least one first laser beam.

3. The system according to claim 1,
wherein the at least one second laser beam of the at least one second laser scanning system runs at an obtuse angle relative to the conveying direction of the conveyor mechanism.

4. The system according to claim 1,
wherein the at least one second laser scanning system is designed as a polar measuring laser scanning system to sweep and/or scan the at least one area of the object to be coated in the monitored area by means of the at least one second laser beam in a direction oblique to the conveying direction.

5. The system according to claim 1,
wherein at least one coating gun is aligned perpendicular to the conveying direction of the conveyor mechanism, and wherein the positioning device is designed to horizontally move the at least one coating gun relative to the coating area perpendicular to the conveying direction of the conveyor mechanism; and/or
wherein the positioning device is designed to vertically move the at least one coating gun relative to the coating area perpendicular to the conveying direction of the conveyor mechanism.

6. The system according to claim 1,
wherein the coating station comprises a plurality of coating guns arranged vertically one above the other, wherein the coating guns are each oriented toward the coating area and are horizontally and/or vertically movable relative to each other and relative to the coating area.

7. The system according to claim 1,
wherein the system comprises at least one coating booth or coating cell, wherein the coating station is arranged at least partially within the at least one coating booth or coating cell.

8. A method for automatic coating of objects with coating material, wherein the method comprises the following method steps:
conveying at least one object to be coated by a conveyor mechanism along a transport path through a coating area of a coating station; and
detecting the presence or absence of an object to be coated in a first monitored area situated in the transport path of the at least one object to be coated and upstream—seen in the conveying direction of the conveyor mechanism—of the coating area;
wherein upon an object to be coated being detected as being present in the first monitored area, coating material is sprayed in the direction of the coating area in the coating station by at least one coating gun after a delay contingent on the conveyance speed and a distance between the first monitored area and the coating area; and
wherein upon an object to be coated not being detected as being present in the first monitored area, no coating material is sprayed in the direction of the coating area in the coating station by the at least one coating gun, in particular after a delay and preferably after a delay contingent on the conveyance speed and a distance between the first monitored area and the coating area,
wherein the method further comprises:
detecting a size, geometry and/or contour of at least one area of the object to be coated in a second monitored area situated in the transport path of the at least one object to be coated and upstream—seen in the conveying direction of the conveyor mechanism—of the coating area;
wherein a positioning device positions and/or aligns at least one coating gun in the coating station in the horizontal and/or vertical direction and/or in the conveying direction in relation to the coating area, particularly after a delay and preferably after a delay contingent on the conveyance speed and a distance between the second monitored area and the coating area, such that when the object to be coated is conveyed through the coating area, the at least one coating gun always has a predefined or definable distance from and/or a predefined or definable orientation to the surface of the object to be coated,
wherein the size, geometry and/or contour of the at least one area of an object to be coated is/are detected by the object being at least partially scanned by means of at least one first laser beam running perpendicular to the conveying direction of the conveyor mechanism and by means of at least one second laser beam running obliquely to the conveying direction of the conveyor mechanism.

9. The system according to claim 1,
wherein the at least one second laser beam of the at least one second laser scanning system runs at an acute angle relative to the conveying direction of the conveyor mechanism.
